(19) United States
(12) Patent Application Publication
(10) Pub. No.: US 2016/0025172 A1
(43) Pub. Date: Jan. 28, 2016

(54) FABRIC-REINFORCED BEARINGS AND METHODS

(71) Applicants: James R. HALLADAY, Erie, PA (US); Frank J. KRAKOWSKI, Erie, PA (US); Haris HAILLOVIC, Erie, PA (US); LORD CORPORATION, Cary (NC)

(72) Inventors: James R. HALLADAY, Erie, PA (US); Frank J. KRAKOWSKI, Erie, PA (US); Haris HALILOVIC, Erie, PA (US)

(73) Assignee: LORD CORPORATION, Cary (NC)

(21) Appl. No.: 14/771,821

(22) PCT Filed: Mar. 13, 2014
(86) PCT No.: PCT/US14/26136

§ 371 Date: Sep. 1, 2015

Related U.S. Application Data
(60) Provisional application No. 61/781,918, filed on Mar. 14, 2013.

(51) Int. Cl. F16F 1/40; B32B 38/18; B32B 37/18

(52) U.S. Cl. CPC F16F 1/40; B32B 37/185; B32B 38/1808; B32B 2319/00; B32B 2311/00; B32B 2305/18

(57) ABSTRACT

A laminated bearing includes a plurality of elastomeric layers (113) and at least one fabric layer (112) arranged between at least two of the elastomeric layers. The at least one fabric layer and the elastomeric layers are bonded together to form at least one bonded laminated portion (110) of the laminated bearing (100), and a plurality of bonded laminated portions comprise the laminated bearing.

### CROSS-REFERENCE TO RELATED APPLICATIONS

The present application claims priority to U.S. Provisional Patent Application No. 61/781,918 filed on Mar. 14, 2013 by James R. Halladay, et al., entitled “FABRIC-REINFORCED HIGH CAPACITY BEARINGS AND METHODS,” which is incorporated by reference herein as if reproduced in its entirety.

### TECHNICAL FIELD

The subject matter disclosed herein relates generally to the design and construction of laminated bearings and related methods.

### BACKGROUND

Current high-capacity laminated (HCL) bearings use thin layers of rubber alternating with thin metal shims to make devices which are relatively stiffer when loaded in compression and relatively softer in shear and torsion. FIG. 1 shows a conventional configuration for such an HCL bearing, generally designated 10, in which alternating layers of rubber 12 and thin metal shims 13 are used to space two structural metal components 11 from each other. In one particular implementation illustrated in FIG. 2, the HCL bearing 10 is used as part of a landing gear pad installation, generally designated 20, in which the HCL bearing 10 is provided on a support bracket 22. In this configuration, as illustrated in FIG. 3, HCL bearing 10 is thus positioned between the support bracket 22 and a landing gear cross-tube CT, which allows the HCL bearing 10 to distribute localized contact forces from the landing gear cross-tube CT to the support bracket 22.

The thin metal shims 13 used in these and other similar implementations are typically thin metal plates (e.g., aluminum, titanium, steel, or stainless steel) that are 0.020 to 0.100 thick and that may be flat, conical, spherical, or tubular in shape. The thin metal shims 13 give support to the layers of rubber 12 in compression. The thin metal shims 13 are generally configured to be capable of handling the compressive loads on the mount as well as supporting the stresses in the hoop direction. The layers of rubber 12 are kept thin to reduce compression bulge strains. As illustrated in FIG. 3, however, HCL bearing 10 needs to be designed to withstand a complex loading even in this configuration since the pure compressive force (i.e., normal force F_{N}) is but one component of a total compressive force F_{C} due to landing gear cross-tube CT often being arranged such that total compressive force F_{C} is applied at an angle with respect to HCL bearing 10 (e.g., angle θ).

In order to accommodate the torsional component of the loading, conventional designs for HCL bearing 10 often require that a significant number of layers of rubber 12 are provided in order to develop an overall thickness of rubber. Because it is desirable to keep the layers of rubber 12 thin and alternatingly layered with the thin metal shims 13, this desired thickness of rubber results in a significant height and weight of the part being taken up by the thin metal shims 13 which are generally at least 0.020 inches thick as a minimum.

There is also a limit to how stiff rubber can be made through filler addition, and beyond a certain point, dynamic and mechanical properties deteriorate with increased filler addition. There is also a physical constraint as to how thin the layers of rubber 12 can be made using current manufacturing methods. Current manufacturing techniques have limited these devices to metal shims with thickness greater than 0.020 inches and generally greater than 0.025 to 0.030 inches in thickness due to constraints in maintaining shim position during molding. These same constraints require that the thin metal shims 13 be located no closer together than 0.020 inches and generally spacing is more typically greater than 0.030 inches. Thus, the layers of rubber 12 are often in excess of 0.020 inches thick. Using extremely thin layers of rubber 12 to gain stiffness means that more layers must be used to obtain a given degree of flexibility. More layers mean more cost in the labor of fabrication of the part, more cost in the materials in the part and more size and weight in the part.

In addition, at least in part because of the stiffness of the thin metal shims 13, they are not able to conform well to the structural components, which results in strain being concentrated in layers of the HCL bearing 10 nearest the point of contact (e.g., in the layer in contact with the landing gear cross-tube). The concentration of strain in the upper layer of the HCL bearing 10 leads to early degradation of elastomer, which further results in undesirable contact between cross-tube CT and the thin metallic shims 13. As a result, it would be desirable for an HCL bearing 10 to be configured to provide the desired balance between stiffness when loaded in compression and elasticity in shear and torsion while minimizing the degradation of elastomer layers in service.

### SUMMARY

In accordance with this disclosure, improvements in the design and construction of and related methods for laminated bearings are provided. In one aspect, a laminated bearing comprises a plurality of elastomeric layers and at least one fabric layer arranged between at least two of the elastomeric layers, the at least one fabric layer and the elastomeric layers being bonded together to form at least one bonded laminated portion of the laminated bearing, wherein a plurality of bonded laminated portions comprise the laminated bearing.

In another aspect, a method for making a laminated bearing comprises arranging a plurality of elastomeric layers, positioning at least one fabric layer between at least two of the elastomeric layers, and bonding the at least one fabric layer and the elastomeric layers together to form a at least one bonded laminated portion of the laminated bearing, wherein a plurality of bonded laminated portions comprise the laminated bearing.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1 is a side view of a high-capacity laminated bearing according to a conventional configuration.

FIG. 2 is a perspective view illustrating a conventional high-capacity laminated bearing configured to be incorporated into a landing gear pad installation.

FIG. 3 is side view of a loading profile of a landing gear pad installation including a high-capacity laminated bearing.

FIG. 4 is a side view illustrating a fiber-reinforced laminated bearing according to an embodiment of the presently disclosed subject matter.

FIG. 5a is a side view illustrating a fiber-reinforced laminated bearing according to an embodiment of the presently disclosed subject matter.

FIG. 5b is a top view illustrating a fabric layer of a fiber-reinforced laminated bearing according to an embodiment of the presently disclosed subject matter.

FIG. 6a is a side view illustrating a fiber-reinforced laminated bearing according to an embodiment of the presently disclosed subject matter.

FIG. 6b is a top view illustrating a fabric layer of a fiber-reinforced laminated bearing according to an embodiment of the presently disclosed subject matter.

FIG. 7 is a side view illustrating a fiber-reinforced laminated bearing according to an embodiment of the presently disclosed subject matter.

FIG. 8 is a top view illustrating a fiber-reinforced laminated bearing according to an embodiment of the presently disclosed subject matter.

FIG. 9 is a perspective view illustrating a fiber-reinforced laminated bearing according to an embodiment of the presently disclosed subject matter configured to be incorporated into a landing gear pad installation.

FIG. 10a is a side perspective view of a conventional laminated bearing in a loaded condition.

FIG. 10b is a side perspective view of a fiber-reinforced laminated bearing according to an embodiment of the presently disclosed subject matter in a loaded condition.

FIG. 11 is a side cutaway view of a leg-mating unit incorporating fiber-reinforced laminated bearings according to an embodiment of the presently disclosed subject matter.

FIG. 12a is a top view of an arrangement of fiber-reinforced laminated bearings according to an embodiment of the presently disclosed subject matter.

FIG. 12b is a side view of the arrangement of fiber-reinforced laminated bearings of FIG. 10a.

FIG. 13 is a top view of a leg-mating unit incorporating fiber-reinforced laminated bearings according to an embodiment of the presently disclosed subject matter.

FIG. 14 is a side cutaway view of a fiber-reinforced laminated bearing according to an embodiment of the presently disclosed subject matter.

FIG. 15 is a side view of a fiber-reinforced laminated bearing incorporated into an industrial vehicle according to an embodiment of the presently disclosed subject matter.

FIG. 16 is a front view of the fiber-reinforced laminated bearing incorporated into the industrial vehicle of FIG. 15.

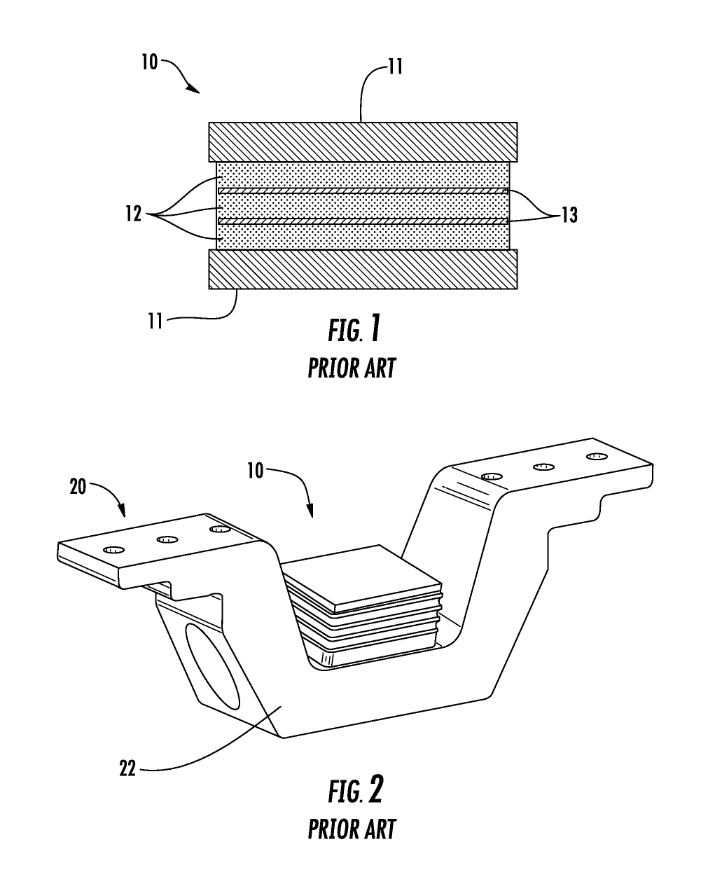

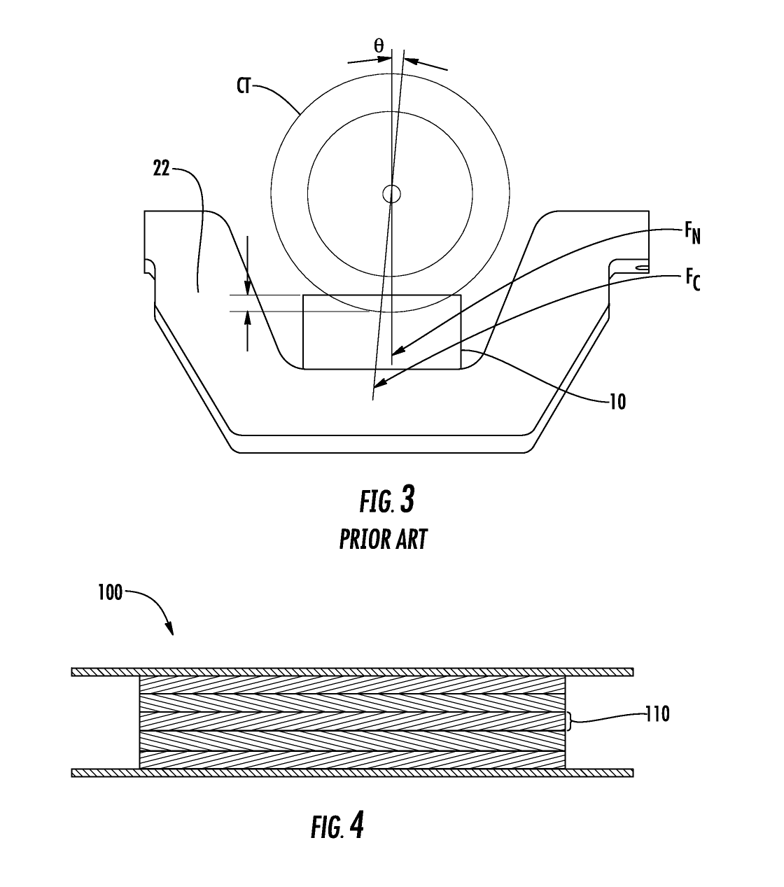

### DETAILED DESCRIPTION

The present subject matter provides improvements in the design and construction of laminated bearings and methods relating thereto. In one aspect, the present subject matter comprises replacing some or all of the metal shims with fabric-reinforced elastomer (e.g., rubber). The use of a fabric-reinforced elastomer rather than metal shims increases the modulus of the elastomer in one or more directions depending on the fabric orientation.

For example, the woven or non-woven fabric anticipated in the disclosure herein may be made from carbon, graphite, glass, aramid, nylon, rayon, polyester, or other fiber materials used in composite structures. It is advantageous in some circumstances for the fabric to be bonded to the elastomer, such as by using commercially available resorcinol formaldehyde latex (RFL) treatments, adhesives such as Chemlok® and combinations thereof. In some embodiments, the fabric is calendered (e.g., by frictioning and/or skimming) or otherwise sandwiched within the elastomer layer prior to assembling the layers for bonding. Alternatively, in some embodiments, the fabric is coated with the elastomer (e.g., by frictioning and/or skimming via calendaring) on only one side of the fabric prior to assembling the layers for bonding. In some embodiments, the specific composition and/or construction is selected to produce a laminated bearing having substantially similar spring characteristics to conventional bearings containing metal shims.

The two-dimensional fabric-elastomer composite is laid up to create a three-dimensional part. As illustrated in FIG. 4, a fabric-reinforced laminated bearing, generally designated 100, is created from bonded laminated portion 110 of fabric-reinforced elastomer. For instance, as illustrated in FIGS. 5a and 5b, portions 110 each comprise one or more fabric layers 112 and one or more elastomeric layers 113 that are laid up and molded (e.g., compressed) into a linear stack. Furthermore, portions 110 are formed such that one or more of fabric layers 112 are encapsulated by one or more surrounding elastomeric layers 113. In the illustrated configuration, elastomeric layers 113 are configured to substantially fill the interstices of fabric layers 112 such that the individual layers of elastomer and fabric are virtually indiscernible. In this regard, many more fabric layers 112 are incorporated into fabric-reinforced laminated bearing 100 compared to the number of metal shims (e.g., two times as many or more) used in conventional bearing designs. This use of a comparatively larger number of fabric layers 112 makes up for the reduced stiffness of the fabric relative to metal, but even with greater numbers of non-elastomer layers being used, a fabric-reinforced laminated bearing 100 formed in this way exhibits substantial weight savings over conventional HCL bearings. In one embodiment, both fabric layers 112 and metal shims are used within the same elastomeric bearing and are positioned on different layers within fabric-reinforced laminated bearing 100.

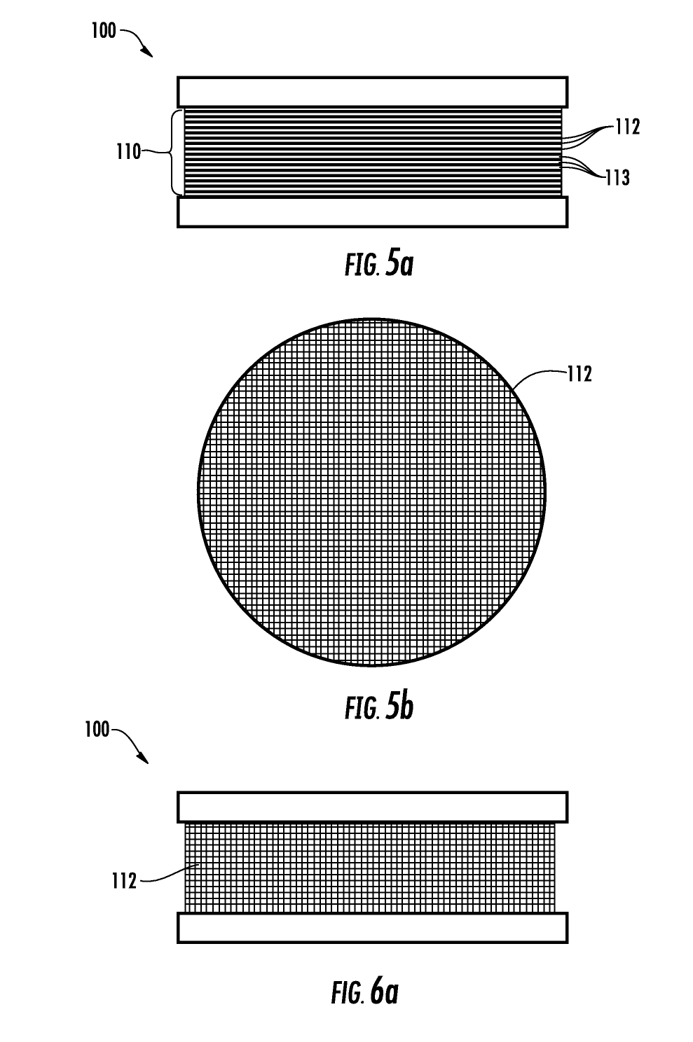

In an alternative configuration illustrated in FIGS. 6a and 6b, portions 110 are created by arranging fabric layers 112 and elastomeric layers 113 in a radial array in which fabric layers 112 and elastomeric layers 113 is arranged in substantially concentric annular shells around a central axis. In this configuration, successive layers of fabric layers 112 and elastomeric layers 113 are laid up and molded about a central core or axis. Alternatively, as discussed above, one or more fabric layers 112 and one or more elastomeric layers 113 can be integrated into discrete “sheets” of substantially two-dimensional, elastomer-coated fabric, which are then arranged in radial layers around a central core or axis.

Using either technique, such a radial configuration is achieved as illustrated in FIG. 6b, by spirally rolling one or more fabric layers 112 and one or more elastomeric layers 113 (e.g., like a jelly-roll) around a central core 115. Where a particular thickness for fabric-reinforced laminated bearing 100 is desired, the spiral roll is sliced into substantially cylindrical sections to place fabric layers 112 in the circumferential or hoop direction. In the configuration illustrated in FIG. 6b, the spiral terminates at some distance from the edge of the component to become only elastomer at a central core 115 (e.g., a rubber core). In an alternative configuration, fabric layers 112 can be wound uninterrupted in this way throughout the cylindrical structure (i.e., to the center of the cylindrical structure). In the illustrated configuration, the spirally-layered component is further encapsulated by a surface coating of elastomeric material (e.g., the outermost layer of each of portions 110 are one of elastomeric layers 113) such that fabric layers 112 are not exposed (i.e., contained entirely within fabric-reinforced laminated bearing 100).

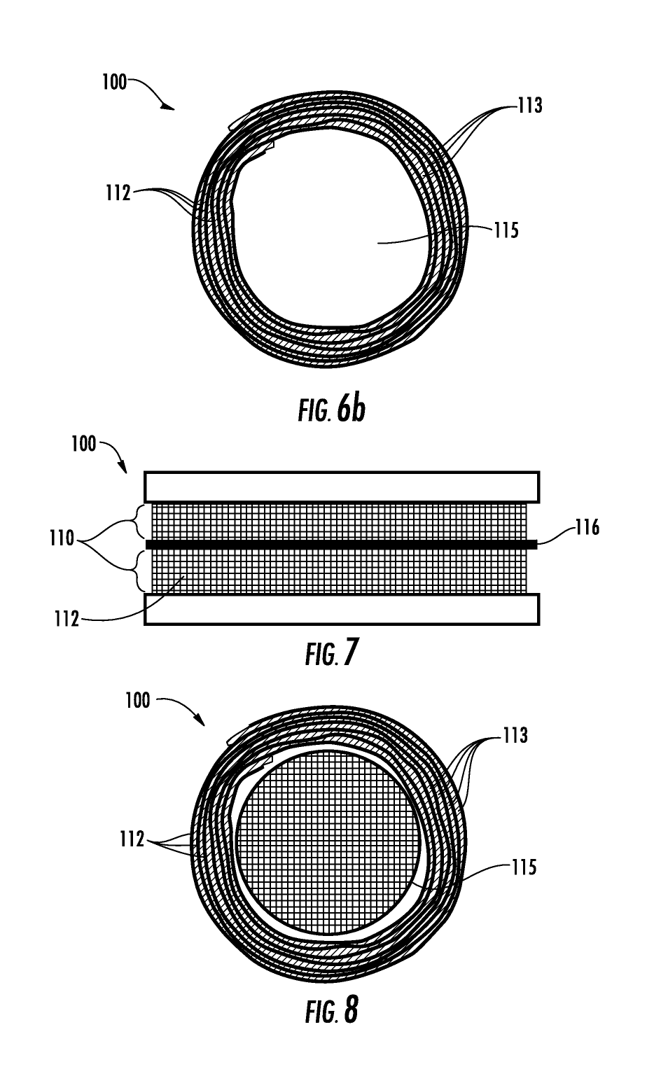

In yet a further alternative configuration, techniques such as those described above are combined with each other or mixed with metal shims to further stiffen the part. As illustrated in FIG. 7, one or more metal shims 116 are positioned between portions 110 of fabric-reinforced composite, which are formed either as a laminated stack (See, e.g., FIGS. 5a and 5b) or as a spirally-wound cylinder (See, e.g., FIGS. 6a and 6b) according to the embodiments discussed above. In still another alternative configuration illustrated in FIG. 8, fabric-reinforced laminated bearing 100 comprises a circumferential fabric wrap as discussed above with reference to FIGS. 6a and 6b, but central core 115 is a layered structure formed in a manner similar to the configurations illustrated in FIGS. 5a and 5b.

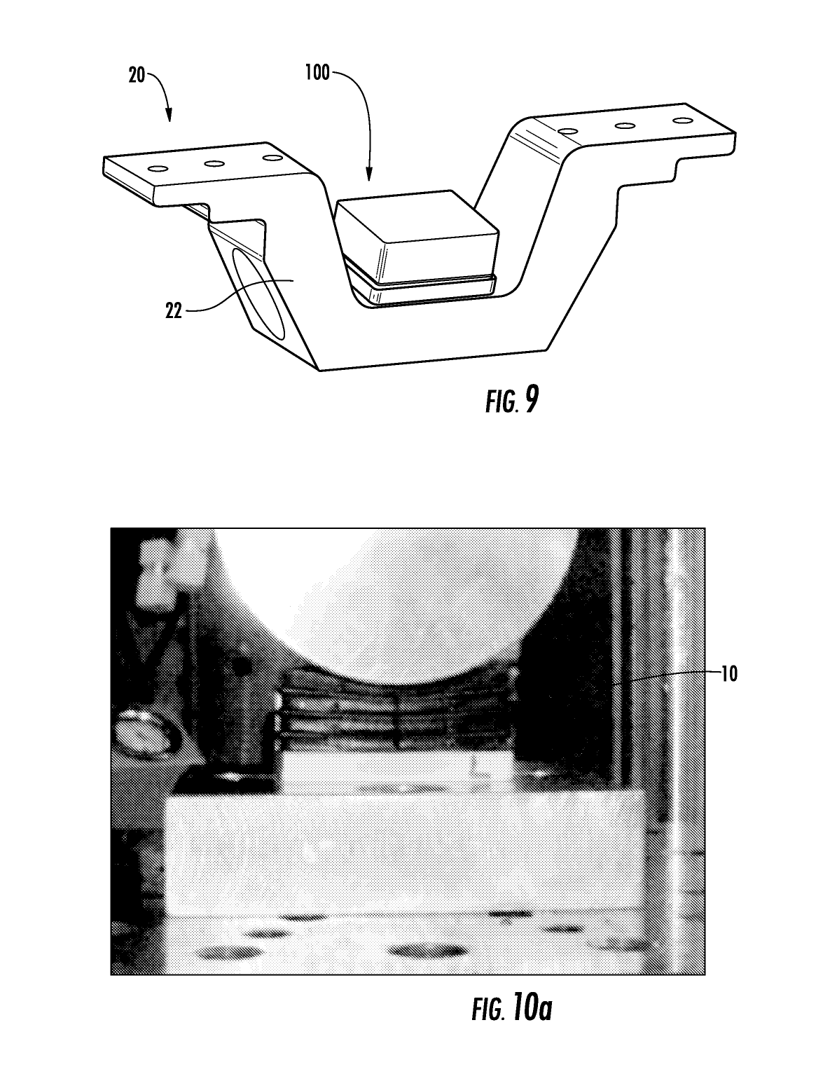

Regardless of the particular configuration, a laminated bearing formed in this manner are adapted to be used in place of conventional designs as part of a landing gear pad installation 20 as illustrated in FIG. 9. Those having ordinary skill in the art will recognize, however, that this is but one of a variety of applications for fabric-reinforced laminated bearing 100. In one additional particular example, for instance, fabric-reinforced laminated bearing 100 are incorporated into a leg mating unit (LMU) used to support platforms in the offshore oil and gas industry. LMUs are used in a float-over process for platform construction in which a topside structure is installed onto a substructure (e.g., jacket). During this process, the load is transferred to the substructure in a controlled manner using LMUs, which conventionally consist of a steel structure incorporating elastomer elements to achieve a specified spring rate. In this regard, one or more of fabric-reinforced laminated bearing 100 are incorporated into each LMU to take up the static load of the topside structure as well as the dynamic load of the topside due to wave conditions.

Referring to FIG. 11, an LMU, generally designated 200, comprises a fabric-reinforced laminated bearing 100, which is made up of an array of portions 110 each having any of the variety of structures discussed above. Portions 110 are arranged about a central core 220 to align portions 110 into a substantially vertical array, to provide moment restraint, and/or to serve as a locking mechanism to keep LMU 200 positioned with respect to the surrounding structural elements. Further in this regard, LMU 200 comprises a gusset assembly 230 to help align and support a deck leg 300 on LMU 200, and LMU 200 is configured to be received by a stabbing cone 310 that aligns and supports LMU 200 in its desired position. As with other applications discussed above, within this general arrangement, fabric-reinforced laminated bearing 100 can be provided in LMU 200 in any of a variety of configurations.

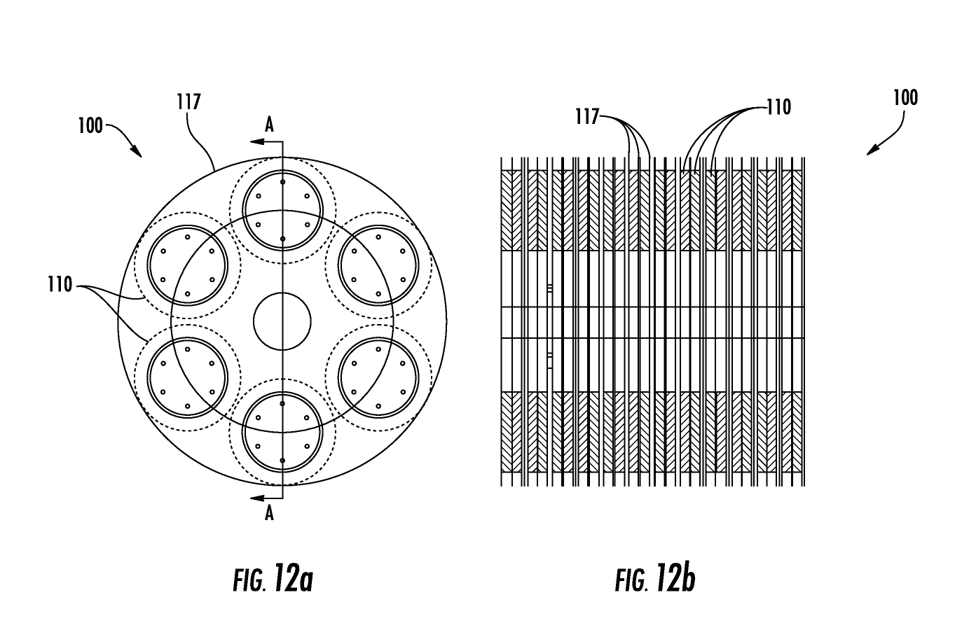

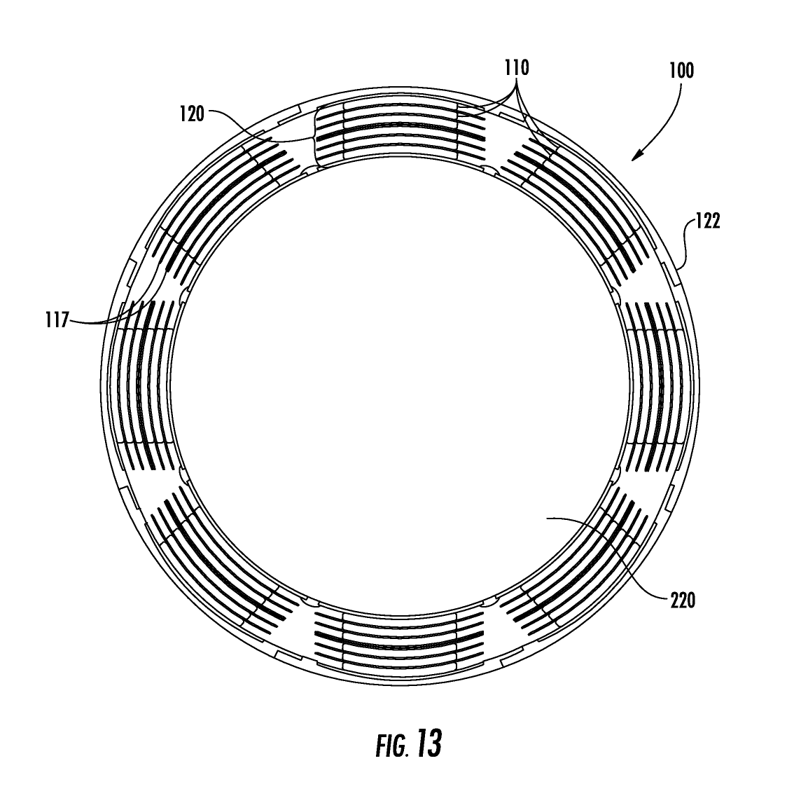

For example, in the configuration illustrated in FIGS. 12a and 12b, a plurality of portions 110 of fabric-reinforced laminated bearing 100 is arranged in a circular array about a center axis (e.g., about central core 220), and one or more layers comprising such arrays of portions 110 are stacked together to form fabric-reinforced laminated bearing 100. Such a configuration is advantageous since each of portions 110 are easier to manufacture and to handle than conventional elastomeric sections for such LMUs. Furthermore, by composing fabric-reinforced laminated bearing 100 of a plurality of smaller portions 110, the particular configuration for LMU 200 is adapted and scaled to the specific parameters of a given installation, thus allowing for a modular approach to the construction of LMU 200. Alternatively, each layer of fabric-reinforced laminated bearing 100 can comprise a single unitary portion 110 having a substantially ring-shaped configuration. As illustrated in FIG. 12b, one or more metal plates 117 is provided between adjacent layers of portions 110 to provide additional rigidity and support to fabric-reinforced laminated bearing 100. Alternatively, metal plates 117 can be omitted to reduce the weight and cost of fabric-reinforced laminated bearing 100.

In another configuration illustrated in FIG. 13, portions 110 are arranged in radial stacks 120 about central core 220. In the illustrated configuration, discrete portions 110 are layered in one of a plurality of radial stacks 120 that are arranged around central core 220. Alternatively, a radial configuration for fabric-reinforced laminated bearing 100 can be created by wrapping or otherwise layering one or more fabric layers 112 and one or more elastomeric layers 113 around central core 220 in a configuration substantially similar to the radial configurations discussed above with respect to FIGS. 6a, 6b, and 8. In either configuration, fabric-reinforced laminated bearing 100 can be post-vulcanization bonded to central core 220, or a mechanical fastener can be used. Furthermore, one or more bearing pads 122 (e.g., Ultra-high-molecular-weight polyethylene pads) can be secured about fabric-reinforced laminated bearing 100 to help to maintain fabric-reinforced laminated bearing 100 in position about central core 220 as illustrated in FIG. 13.

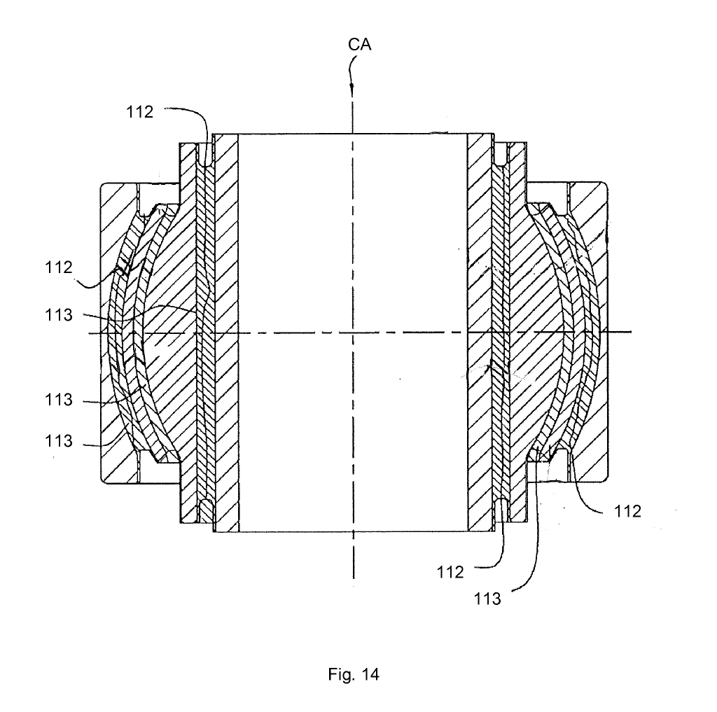

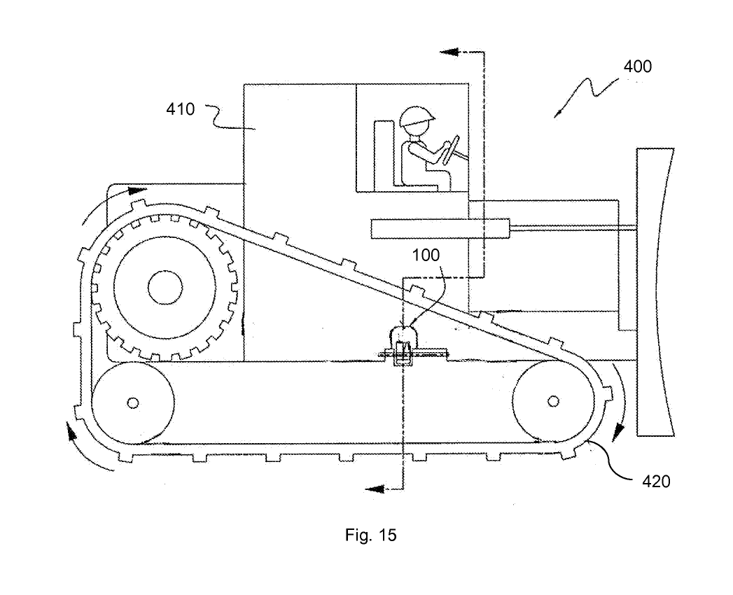

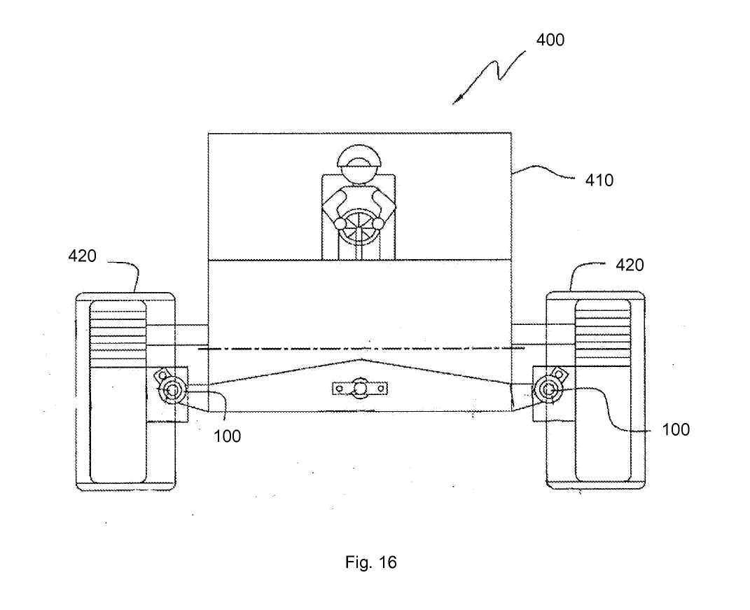

In yet a further particular example, fabric-reinforced laminated bearing 100 is incorporated into industrial vehicles (e.g., bulldozers, plows) to help reduce and control gross vehicle cab vibrations. In the configuration illustrated in FIG. 14, for example, a fabric-reinforced laminated bearing 100 is made up of an assembly of portions 110 arranged in a radial array about a center axis CA. One or more of portions 110 includes at least one fabric layer 112 arranged between at least two of a plurality of elastomeric layers 113, at least one fabric layer 112 and elastomeric layers 113 being bonded together to form a respective one of portions 110 of laminated bearing 100. In this arrangement, laminated bearing 100 is incorporated into an industrial vehicle as illustrated in FIGS. 15 and 16. In particular, as shown in FIGS. 15 and 16, the industrial vehicle, generally designated 400, uses one or more of fabric-reinforced laminated bearing 100 to couple a vehicle cab 410 to one or more treads 220.

In addition to these exemplary implementations of fabric-reinforced laminated bearing 100 described herein, those having skill in the art should recognize that fabric-reinforced laminated bearing 100 can be implemented in any of a variety of other applications in which compressive load distribution, vibration control, or other damping is desired. For example fabric-reinforced laminated bearing 100 may be a fluid damper configured to support loads and motions, encapsulate a fluid while maintaining a constant fluid pressure within the fluid damper. This type of fabric-reinforced laminated carries load, accommodates motions and also serves as a seal.

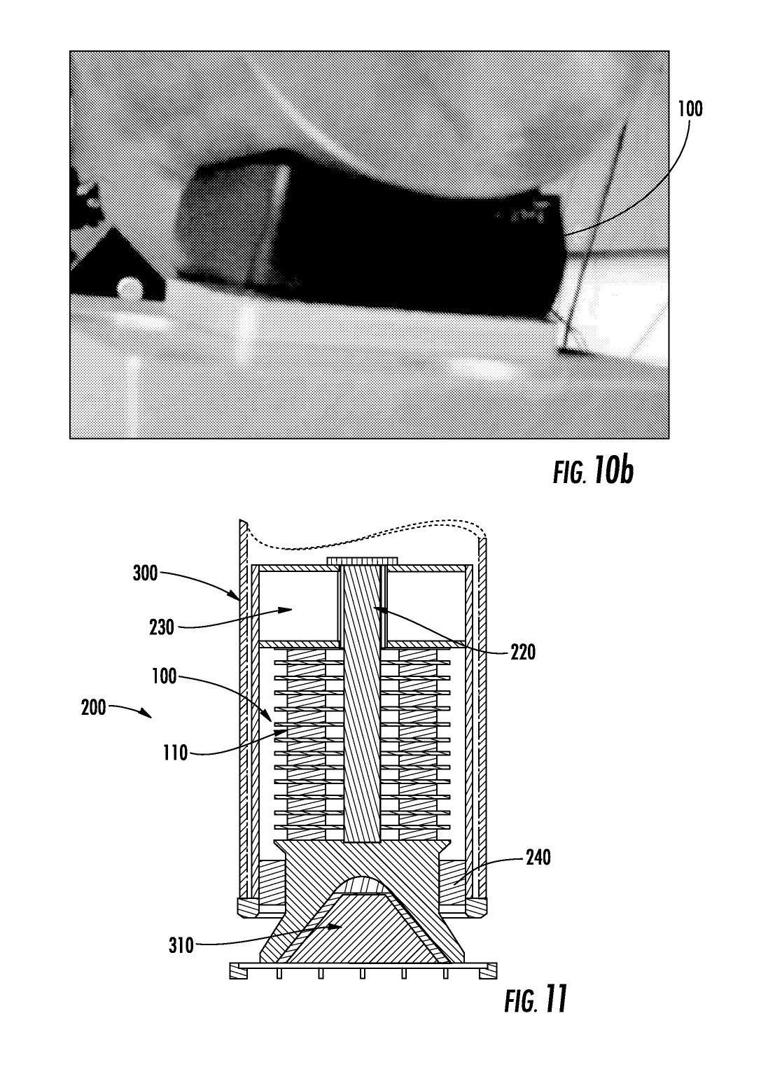

Regardless of the specific implementation, fabric-reinforced laminated bearing 100 more evenly distribute loads, thereby increasing the potential for a long service life. For example, by comparing the performance of both conventional HCL bearing 10 and fabric-reinforced laminated bearing 100 over 50,000 fatigue cycles, it has been shown that localized damage to the top layers of the component is reduced in the fabric-reinforced design compared to the conventional construction. Again, this difference exists because whereas strain applied to conventional HCL bearing 10 would be localized to a top layer as illustrated in FIG. 10a, fabric-reinforced laminated bearing 100 allow more uniform strain distribution as illustrated in Figure 10b. Further in this regard, those having skill in the art will recognize that this improved performance of fabric-reinforced laminated bearing 100 with respect to conventional HCL bearing 10 is not limited to the particular application of HCL bearings, but rather is seen in any of the variety of applications to which fabric-reinforced laminated bearing 100 can be applied (e.g., in particular, LMU 200 or industrial vehicle 400 discussed above).

In addition, by eliminating (or at least minimizing) the use of metal shims (e.g., metal shims 13), the potential for metal-to-metal contact is eliminated. For example, even as elastomeric layers 113 degrade over time and through use, there need not be any metallic component (e.g., metal shims 13) contained within the fabric-reinforced bearing. Rather, elastomeric layers 113 in according to the present subject matter are enhanced via fabric layers 112 rather than via metal shims as discussed above. As a result, the risks associated with contact between a metal structural component carried by fabric-reinforced laminated bearing 100 (e.g., support bracket 22 for a metal landing gear, deck leg 300) and another metal component are reduced or eliminated.

Furthermore, whereas the methods for constructing conventional HCL bearings often required that the metal shims extend beyond the lateral extent of the elastomeric material (e.g., to allow the metal shims to be held in place relative to the elastomer layers during molding), fabric-reinforced laminated bearing 100 according to the presently-disclosed subject matter can be configured such that fabric layers 112 are completely encapsulated within one or more of elastomeric layers 113, leaving no exposed edges. (See, e.g., FIGS. 9 and 10b)

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A laminated bearing comprising:
a plurality of elastomeric layers; and
at least one fabric layer arranged between at least two of the elastomeric layers, the at least one fabric layer and the elastomeric layers being bonded together to form at least one bonded laminated portion of the laminated bearing;
wherein a plurality of bonded laminated portions comprise the laminated bearing.

2. The laminated bearing of claim 1, wherein the one or more fabric layers comprise fiber materials selected from the group consisting of carbon, graphite, glass, aramid, nylon, rayon, and polyester.

3. The laminated bearing of claim 1, wherein the elastomeric layers are arranged in a linear stack.

4. The laminated bearing of claim 1, wherein the elastomeric layers are spirally-wound about a center axis.

5. The laminated bearing of claim 4, wherein the elastomeric layers are spirally-wound about an elastomeric core.

6. The laminated bearing of claim 4, wherein the elastomeric layers are spirally-wound about a linear stack of fabric-reinforced elastomer layers.

7. The laminated bearing of claim 4, comprising a surface coating of elastomeric material over the elastomeric layers and the at least one fabric layer.

8. The laminated bearing of claim 1, wherein the at least one fabric layer is encapsulated within the elastomeric layers.

9. The laminated bearing of claim 1, wherein the at least one fabric layer is arranged concentrically about a center axis.

10. The laminated bearing of claim 1, wherein the at least one fabric layer and the elastomeric layers are selected such that the laminated bearing exhibits spring characteristics that are substantially similar to spring characteristics of bearings containing layers of elastomeric material and metal shims.

11. The laminated bearing of claim 1, further comprising one or more rigid shims arranged between at least two of the bonded laminated portions.

12. The laminated bearing of claim 1, further comprising at least two structural components, the laminated bearing being disposed therebetween.

13. The laminated bearing of claim 1, wherein the laminated bearing is configured to support loads and motions, and encapsulates a fluid while maintaining a constant fluid pressure within a fluid damper.

14. The laminated bearing of claim 1, further comprising metal shims, wherein the laminated bearing includes at least one fabric layer and at least one metal shim, wherein the at least one fabric layer and at least one metal shim are positioned on different layers within the laminated bearing.

15. A method for making a laminated bearing, the method comprising:
arranging a plurality of elastomeric layers;
positioning at least one fabric layer between at least two of the elastomeric layers; and
bonding the at least one fabric layer and the elastomeric layers together to form at least one bonded laminated portion of the laminated bearing, wherein a plurality of bonded laminated portions comprise the laminated bearing.

16. The method of claim 15, wherein the step of arranging the elastomeric layers further comprises arranging the elastomeric layers in a linear stack.

17. The method of claim 15, wherein the step of arranging the elastomeric layers further comprises spirally winding the elastomeric layers about a center axis of the elastomeric layers.

18. The method of claim 17, wherein the step of spirally winding the elastomeric layers about the center axis further comprises spirally winding the elastomeric layers about an elastomeric core.

19. The method of claim 17, wherein the step of spirally winding the elastomeric layers about the center axis further comprises spirally winding the elastomeric layers about a linear stack of fabric-reinforced elastomer layers.

20. The method of claim 17, wherein the step of positioning the at least one fabric layer between at least two of the elastomeric layers includes coating the at least one fabric layer with elastomeric materials prior to spirally winding the elastomeric layers about the center axis.

21. The method of claim 17, further comprising encapsulating the elastomeric layers and the at least one fabric layer with a surface coating of elastomeric material.

22. The method of claim 15, wherein the step of positioning the at least one fabric layer between at least two of the elastomeric layers comprises arranging the at least one fabric layer concentrically about a center axis of the elastomeric layers.

23. The method of claim 15, wherein the step of bonding the at least one fabric layer and the elastomeric layers together further comprises:
applying one or more of resorcinol formaldehyde latex (RFL) treatments, adhesives and combinations thereof to the at least one fabric layer; and
adhering the at least one fabric layer to the elastomeric layers.

24. The method of claim 15, wherein the step of bonding the at least one fabric layer and the elastomeric layers together further comprises frictioning or skimming via calendering the at least one fabric layer within the elastomeric layers prior to assembling the elastomeric layers for bonding.

25. The method of claim 15, wherein the step of bonding the at least one fabric layer and the elastomeric layers together further comprises encapsulating the at least one fabric layer within the elastomer sections.

26. The method of claim 15, wherein the method further comprises positioning one or more rigid shims between at least two of the bonded laminated portions.
